(19) United States
(12) Patent Application Publication
(10) Pub. No.: US 2015/0131719 A1
(43) Pub. Date: May 14, 2015

(54) RATE-DISTORTION OPTIMIZED QUANTIZATION METHOD

(71) Applicant: National Taiwan University, Taipei (TW)

(72) Inventors: Tsung-Yau HUANG, Taipei (TW); Homer H. CHEN, Taipei (TW); Chieh-Kai KAO, Taipei (TW)

(73) Assignee: National Taiwan University, Taipei (TW)

(21) Appl. No.: 14/154,103

(22) Filed: Jan. 13, 2014

(30) Foreign Application Priority Data
Nov. 12, 2013 (TW) 102141141

(51) Int. Cl. H04N 19/147; H04N 19/18; H04N 19/124

(52) U.S. Cl. CPC H04N 19/147; H04N 19/124; H04N 19/18
USPC 375/240.03

(57) ABSTRACT

A rate-distortion optimized quantization method includes determining a rate model and a distortion model respectively, establishing a rate-distortion objective function according to the rate model and the distortion model, estimating a closed-form solution for the rate-distortion objective function, and according to an input frame generating quantized transform coefficients using the closed-form solution.

### BACKGROUND OF THE INVENTION

1. Field of the Invention

The present invention generally relates to video coding, and more particularly to a method of rate-distortion optimized quantization.

2. Description of Related Art

Conventional rate-distortion optimized quantization methods can require an exhaustive search process and a redundantly entropy coding process. For this reason, the computational cost of coding performance of conventional methods is high, and the computational efficiency of conventional methods is low.

A need has thus arisen to develop a novel scheme with high efficiency and low computational complexity for a video coding process.

### SUMMARY OF THE INVENTION

In view of the foregoing, it is an object of the embodiment of the present invention to provide a rate-distortion optimized quantization method that allows the bitrate of quantized transform coefficient(s) to be efficiently estimated in an offline state. Another object of the embodiment of the present invention is to provide a closed-form solution for quantized transform coefficients of the rate-distortion optimized quantization, in order to simplify the computational process and substantially (e.g., greatly) reduce the computational cost.

According to one embodiment, the rate-distortion optimized quantization method includes the steps of determining a rate model and a distortion model respectively, establishing a rate-distortion objective function according to the rate model and the distortion model, estimating a closed-form solution for the rate-distortion objective function, and generating quantized transform coefficients by way of the closed-form solution according to an input frame.

### BRIEF DESCRIPTION OF THE DRAWINGS

FIG. 1 is a flow diagram of a rate-distortion optimized quantization method according to one embodiment of the present invention; and

FIG. 2 is a block diagram of an iterative training scheme for estimating the optimal model parameters in the offline state.

### DETAILED DESCRIPTION OF THE INVENTION

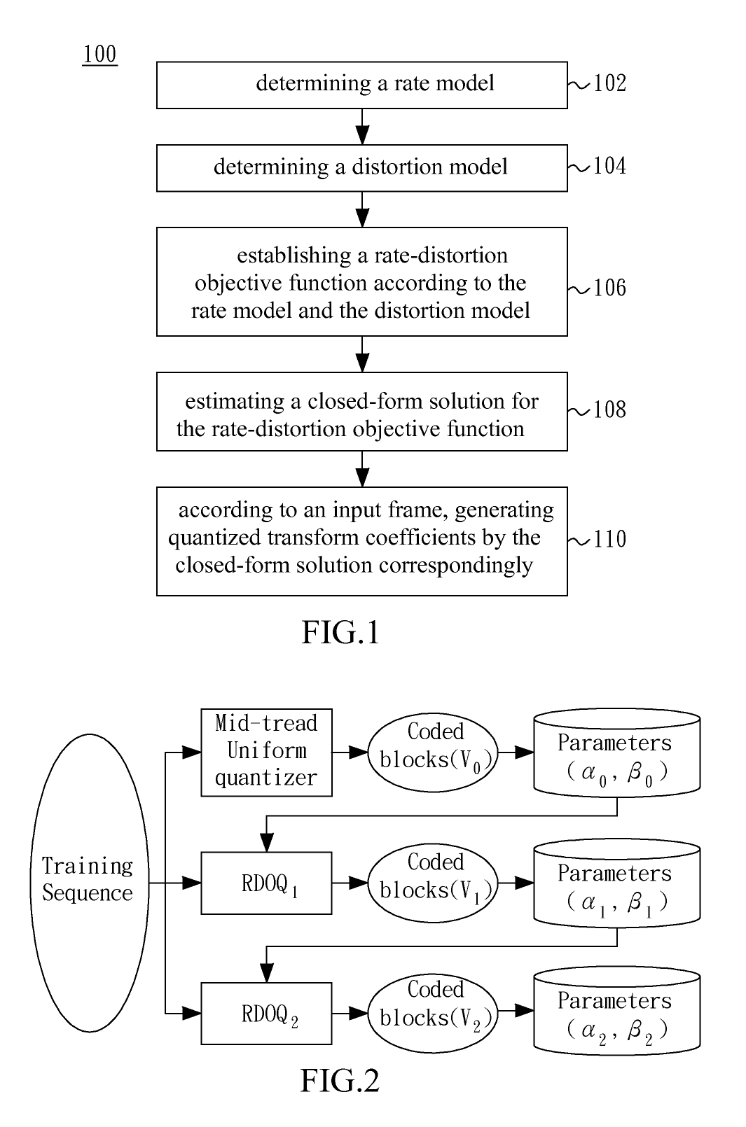

Referring more particularly to the drawings, FIG. 1 shows a flow diagram of a rate-distortion optimized quantization method 100, which may be performed by a processor (e.g., a digital image processor), software or their combination, according to an embodiment of the present invention. The embodiment illustrated below may be adapted to, but is not limited to, a H.264/AVC coding standard.

At step 102, the method 100 determines a rate model. In one embodiment, the rate model is generated by using a preset quantizer and a plurality of training sequences to perform an iterative process. The preset quantizer may be a mid-tread uniform quantizer. More particularly, in the embodiment, the rate model is determined on the basis of information theory, as shown below:

$$\overline{R} ( {x}_{1} , … , {x}_{n} ) = α {\sum }_{i = 1}^{N} \vert {x}_{i} \vert + β {\sum }_{i = 1}^{N} {‖ {x}_{i} ‖}_{0} + γ \qquad ( 1 )$$

wherein α, β and γ are model parameters, |xᵢ| is one norm of the quantized transform coefficient xᵢ, which is defined as the absolute value of xᵢ, ∥xᵢ∥₀ is zero norm of the quantized transform coefficient xᵢ,

$${‖ {x}_{i} ‖}_{0} = \{ \begin{matrix}0 , & {x}_{i} = 0 \\ 1 , & {x}_{i} \neq 0\end{matrix} .$$

According to one aspect of the embodiment, the model parameters α and β may be determined by training in the offline state. On the other hand, when each quantized transform coefficient xᵢ is zero, it will result in a zero bitrate, and therefore the least one model parameter γ is directly set to be zero. Accordingly, the rate model may be expressed as follows:

$$\overline{R} ( {x}_{1} , … , {x}_{n} ) = α {\sum }_{i = 1}^{N} \vert {x}_{i} \vert + β {\sum }_{i = 1}^{N} {‖ {x}_{i} ‖}_{0} \qquad ( 2 )$$

Referring to FIG. 2, a block diagram is provided outlining an iterative training scheme for estimating the optimal model parameters α and β in the offline state.

At first, the mid-tread uniform quantizer is applied to encode a plurality of the training sequences to obtain a set of coded blocks Vo, which are then used to train model parameters α₀ and β₀. In this embodiment, the mid-tread uniform quantizer is shown as follows:

$${x}_{i} = sign ( {t}_{i} ) \cdot ⌊ \frac{\vert {t}_{i} \vert}{{s}_{i} {Q}_{S}} + f ⌋$$

where └•┘ denotes a floor operation, Qₛ denotes a quantization step size, Sᵢ is a predefined scale factor, tᵢ is a transform coefficient(s) of the coding block, f is rounding offset. In this embodiment, f is set to 0.5.

Afterwards, the model parameters α₀ and β₀ are used to activate an analytical RDOQ process, in order to generate an update quantizer (RDOQ₁). Then, the same training sequences are encoded with RDOQ₁ to generate a set of coded block V₁, which are further used for training another set of model parameters α₁ and β₁. Repeatedly, the resulting model parameters α₁ and β₁ are used to activate an analytical RDOQ process, so as to generate another update quantizer (RDOQ₂) correspondingly. Thus, according to the iterative training scheme mentioned above, the kth model parameters αₖ₋₁ and βₖ₋₁, which are convergent, may eventually be obtained, and therefore the optimal model parameters α and β of the rate model can be well predicted. Simultaneously, the optimal model parameters α and β of the rate model may be well predicted with any possible input training sequence in the offline state, in order to establish an optimal model parameter table for the rate model in advance.

In step 104, the method 100 determines a distortion model. In one embodiment, the distortion model is measured by the sum of squared error (SSE) between the residual signals r, which are obtained by subtracting the (intra/inter) predicted signal from an input signal, and the corresponding reconstructed residual signals \tilde{r}, and therefore the distortion model can be expressed as follows:

$$\overline{D} = {\sum }_{i = 1}^{N} ( {‖ {A}_{i} ‖}_{2}^{2} {s}_{i}^{2} {{Q}_{S}^{2} ( {x}_{i} - \frac{{t}_{i}}{{s}_{i} {Q}_{S}} )}^{2} ) \qquad ( 3 )$$

where A is an inverse transform matrix, ∥ ∥₂ denotes two norm, which is defined as a sum of squared values of all elements therein, Aᵢ denotes ith column vector of A, and tᵢ is the transform coefficient of the coding block.

In step 106, the rate model and the distortion model expressed in (2) and (3) are substituted in the flowing rate-distortion minimization formulation, which is expressed as:

$${\hat{x}}_{1} , … , {\hat{x}}_{n} = arg {min}_{{x}_{i} , … , {x}_{n}} ( \begin{matrix}\overline{D} ( {t}_{1} , … , {t}_{n} , {x}_{1} , … , {x}_{n} ) + \\ λ \overline{R} ( {x}_{1} , … , {x}_{n} )\end{matrix} ) \qquad ( 4 )$$

where \hat{x} are optimal quantized transform coefficients, D̅ denotes the distortion model, and R̅ denotes the rate model.

Hence, the rate-distortion objective function, with the consideration of mutual effect between the quantization and the rate model, may be well established as follows:

$${\hat{x}}_{1} , … , {\hat{x}}_{n} = arg {min}_{{x}_{i} , … , {x}_{n}} {\sum }_{i = 1}^{N} ( \begin{matrix}{‖ {A}_{i} ‖}_{2}^{2} {s}_{i}^{2} {{Q}_{S}^{2} ( {x}_{i} - \frac{{t}_{i}}{{s}_{i} {Q}_{S}} )}^{2} + \\ λ α \vert {x}_{i} \vert + λ β {‖ {x}_{i} ‖}_{0}\end{matrix} ) \qquad ( 5 )$$

As each quantized transform coefficient xᵢ in (5) is obviously separated from the other, each quantized transform coefficient xᵢ therefore may be solved independently, so as to obtain an optimal quantized transform coefficient \hat{x}ᵢ by an independent formulation as:

$${\hat{x}}_{i} = arg {min}_{{x}_{i}} ( \begin{matrix}{‖ {A}_{i} ‖}_{2}^{2} {s}_{i}^{2} {{Q}_{S}^{2} ( {x}_{i} - \frac{{t}_{i}}{{s}_{i} {Q}_{S}} )}^{2} + \\ λ α \vert {x}_{i} \vert + λ β {‖ {x}_{i} ‖}_{0}\end{matrix} ) \qquad ( 6 )$$

Then, in step 108, according to one aspect of the embodiment, a closed-form solution may be derived from (6) as follows:

$${\hat{x}}_{i} = \{ \begin{matrix}0 , & \frac{\vert {t}_{i} \vert}{{s}_{i} {Q}_{S}} < {Z}_{i} \\ sign ( {t}_{i} ) \cdot 1 , & {Z}_{i} \leq \frac{\vert {t}_{i} \vert}{{s}_{i} {Q}_{S}} < \frac{1}{2} + \frac{λ α}{2 {‖ {A}_{i} ‖}_{2}^{2} {s}_{i}^{2} {Q}_{S}^{2}} \\ sign ( {t}_{i} ) \cdot ⌊ \frac{\vert {t}_{i} \vert}{{s}_{i} {Q}_{S}} + {f}_{i} ⌋ , & otherwise\end{matrix} \\ where \\ {Z}_{i} = \frac{{\hat{L}}_{i}}{2} + \frac{λ ( α {\hat{L}}_{i} + β )}{2 {‖ {A}_{i} ‖}_{2}^{2} {s}_{i}^{2} {Q}_{S}^{2} {\hat{L}}_{i}} \\ and \\ {f}_{i} = \frac{1}{2} - \frac{λ α}{2 {‖ {A}_{i} ‖}_{2}^{2} {s}_{i}^{2} {Q}_{S}^{2}} ; \\ {\hat{L}}_{i} = \{ \begin{matrix}1 , & \frac{λ β}{{‖ {A}_{i} ‖}_{2}^{2} {s}_{i}^{2} {Q}_{S}^{2}} \leq 1 \\ ⌊ \vert {\hat{l}}_{i} \vert ⌋ , & \frac{λ β}{{‖ {A}_{i} ‖}_{2}^{2} {s}_{i}^{2} {Q}_{S}^{2}} > 1 and \frac{⌊ \vert {\hat{l}}_{i} \vert ⌋}{2} + \frac{λ ( α ⌊ \vert {\hat{l}}_{i} \vert ⌋ + β )}{2 {‖ {A}_{i} ‖}_{2}^{2} {s}_{i}^{2} {Q}_{S}^{2} ⌊ \vert {\hat{l}}_{i} \vert ⌋} < \\ & \frac{⌈ \vert {\hat{l}}_{i} \vert ⌉}{2} + \frac{λ ( α ⌈ \vert {\hat{l}}_{i} \vert ⌉ + β )}{2 {‖ {A}_{i} ‖}_{2}^{2} {s}_{i}^{2} {Q}_{S}^{2} ⌈ \vert {\hat{l}}_{i} \vert ⌉} \\ ⌈ \vert {\hat{l}}_{i} \vert ⌉ , & otherwise\end{matrix} ;$$

and

$${\hat{l}}_{i} \pm \sqrt{\frac{λ β}{{‖ {A}_{i} ‖}_{2}^{2} {s}_{i}^{2} {Q}_{S}^{2}}} ,$$

and ┌┐ is a ceiling operation.

In step 110, each input frame is applied to the closed-form solution mentioned above for generating the correspondingly optimal quantized transform coefficients. More particularly, as the model parameters α and β of the closed-form solution may be trained to obtain and establish a model parameter table, thus when the coding process is applied to one input frame, the correspondingly optimal model parameters α and β can be immediately provided by dynamically checking the model parameter table according to the feature of the input frame. Therefore, the computational cost of rate-distortion optimized quantization is greatly reduced.

According to the method 100 and the disclosed rate-distortion model thereof discussed above, the coding efficiency and reliability of the present embodiment may be significantly enhanced and improved. Further, compared with the conventional methods, this embodiment may immediately provide the optimal model parameters by checking table according to the feature of the input frame, so as to greatly reduce the computational cost.

Although specific embodiments have been illustrated and described, it will be appreciated by those skilled in the art that various modifications may be made without departing from the scope of the present invention, which is intended to be limited solely by the appended claims.

What is claimed is:

1. A rate-distortion optimized quantization (RDOQ) method, which is performed by at least one processor, comprising:
determining a rate model;
determining a distortion model;
establishing a rate-distortion objective function according to the rate model and the distortion model;
estimating a closed-form solution for the rate-distortion objective function; and
according to an input frame, generating quantized transform coefficients via the closed-form solution.

2. The rate-distortion optimized quantization method of claim 1, wherein at least one model parameter of the rate model is generated according to a preset quantizer and a plurality of training sequences.

3. The rate-distortion optimized quantization method of claim 1, wherein the distortion model is measured by using a sum of squared error (SSE).

4. The rate-distortion optimized quantization method of claim 1, wherein the rate model is expressed as:
$$\overline{R} ( {x}_{1} , … , {x}_{n} ) = α {\sum }_{i = 1}^{N} \vert {x}_{i} \vert + β {\sum }_{i = 1}^{N} {‖ {x}_{i} ‖}_{0} + γ$$
wherein xᵢ is a quantized transform coefficient, α, β and γ are model parameters, |xᵢ| is one norm of the quantized transform coefficient xᵢ, and ∥xᵢ∥₀ is zero norm of the quantized transform coefficient xᵢ,
$${‖ {x}_{i} ‖}_{0} = \{ \begin{matrix}0 , & {x}_{i} = 0 \\ 1 , & {x}_{i} \neq 0\end{matrix} .$$

5. The rate-distortion optimized quantization method of claim 2, wherein the preset quantizer is a mid-tread uniform quantizer:
$${x}_{i} = sign ( {t}_{i} ) \cdot ⌊ \frac{\vert {t}_{i} \vert}{{s}_{i} {Q}_{S}} + f ⌋$$
where └•┘ denotes a floor operation, Qₛ denotes a quantization step size, Sᵢ is a predefined scale factor, tᵢ is a transform coefficients of the coding block, and f is rounding offset.

6. The rate-distortion optimized quantization method of claim 5, wherein the rounding offset is set to 0.5.

7. The rate-distortion optimized quantization method of claim 1, wherein the distortion model measured by sum of squared error (SSE) is expressed as:
$$D = {\sum }_{i = 1}^{N} ( {‖ {A}_{i} ‖}_{2}^{2} {s}_{i}^{2} {{Q}_{S}^{2} ( {x}_{i} - \frac{{t}_{i}}{{s}_{i} {Q}_{S}} )}^{2} )$$
wherein A is an inverse transform matrix, ∥ ∥₂ denotes two norm, which is defined as a sum of squared values of all elements therein, Aᵢ denotes ith column vector of A, and tᵢ is the transform coefficient of the coding block.

8. The rate-distortion optimized quantization method of claim 1, wherein the rate-distortion objective function is obtained by a rate-distortion minimization formulation as follows:
$${\hat{x}}_{1} , … , {\hat{x}}_{n} = arg {min}_{{x}_{i} , … , {x}_{n}} ( \begin{matrix}\overline{D} ( {t}_{1} , … , {t}_{n} , {x}_{1} , … , {x}_{n} ) + \\ λ \overline{R} ( {x}_{1} , … , {x}_{n} )\end{matrix} )$$
wherein \hat{x} are optimal quantized transform coefficients, D̅ denotes the distortion model, and R̅ denotes the rate model.

9. The rate-distortion optimized quantization method of claim 8, wherein the rate-distortion objective function is established according to the rate model and the distortion model, expressed as:
$${\hat{x}}_{1} , … , {\hat{x}}_{n} = arg {min}_{{x}_{i}} {\sum }_{i = 1}^{N} ( \begin{matrix}{‖ {A}_{i} ‖}_{2}^{2} {s}_{i}^{2} {{Q}_{S}^{2} ( {x}_{i} - \frac{{t}_{i}}{{s}_{i} {Q}_{S}} )}^{2} + \\ λ α \vert {x}_{i} \vert + λ β {‖ {x}_{i} ‖}_{0}\end{matrix} )$$

10. The rate-distortion optimized quantization method of claim 9, wherein each quantized transform coefficient xᵢ has a corresponding closed-form solution as follows:
$${\hat{x}}_{i} = \{ \begin{matrix}0 , & \frac{\vert {t}_{i} \vert}{{s}_{i} {Q}_{S}} < {Z}_{i} \\ sign ( {t}_{i} ) \cdot 1 , & {Z}_{i} \leq \frac{\vert {t}_{i} \vert}{{s}_{i} {Q}_{S}} < \frac{1}{2} + \frac{λ α}{2 {‖ {A}_{i} ‖}_{2}^{2} {s}_{i}^{2} {Q}_{S}^{2}} \\ sign ( {t}_{i} ) \cdot ⌊ \frac{\vert {t}_{i} \vert}{{s}_{i} {Q}_{S}} + {f}_{i} ⌋ , & otherwise\end{matrix} \\ wherein \\ {Z}_{i} = \frac{{\hat{L}}_{i}}{2} + \frac{λ ( α {\hat{L}}_{i} + β )}{2 {‖ {A}_{i} ‖}_{2}^{2} {s}_{i}^{2} {Q}_{S}^{2} {\hat{L}}_{i}} \\ and \\ {f}_{i} = \frac{1}{2} - \frac{λ α}{2 {‖ {A}_{i} ‖}_{2}^{2} {s}_{i}^{2} {Q}_{S}^{2}} ;$$
and wherein
$${\hat{L}}_{i} = \{ \begin{matrix}1 , & \frac{λ β}{{‖ {A}_{i} ‖}_{2}^{2} {s}_{i}^{2} {Q}_{S}^{2}} \leq 1 \\ ⌊ \vert {\hat{l}}_{i} \vert ⌋ , & \frac{λ β}{{‖ {A}_{i} ‖}_{2}^{2} {s}_{i}^{2} {Q}_{S}^{2}} > 1 and \frac{⌊ \vert {\hat{l}}_{i} \vert ⌋}{2} + \frac{λ ( α ⌊ \vert {\hat{l}}_{i} \vert ⌋ + β )}{2 {‖ {A}_{i} ‖}_{2}^{2} {s}_{i}^{2} {Q}_{S}^{2} ⌊ \vert {\hat{l}}_{i} \vert ⌋} < \\ & \frac{⌈ \vert {\hat{l}}_{i} \vert ⌉}{2} + \frac{λ ( α ⌈ \vert {\hat{l}}_{i} \vert ⌉ + β )}{2 {‖ {A}_{i} ‖}_{2}^{2} {s}_{i}^{2} {Q}_{S}^{2} ⌈ \vert {\hat{l}}_{i} \vert ⌉} \\ ⌈ \vert {\hat{l}}_{i} \vert ⌉ , & otherwise\end{matrix} ,$$
and
$${\hat{l}}_{i} \pm \sqrt{\frac{λ β}{{‖ {A}_{i} ‖}_{2}^{2} {s}_{i}^{2} {Q}_{S}^{2}}} ,$$
and ┌┐ is a ceiling operation.
